(19) United States
(12) Patent Application Publication
(10) Pub. No.: US 2017/0192574 A1
(43) Pub. Date: Jul. 6, 2017

(54) LAMINATE STRUCTURE, TOUCH PANEL, DISPLAY DEVICE WITH TOUCH PANEL, AND METHOD OF MANUFACTURING SAME

(71) Applicant: FUJIFILM Corporation, Tokyo (JP)

(72) Inventors: Takashi KOIKE, Ashigara-kami-gun (JP); Hiroyuki KOBAYASHI, Ashigara-kami-gun (JP)

(73) Assignee: FUJIFILM Corporation, Tokyo (JP)

(21) Appl. No.: 15/455,542

(22) Filed: Mar. 10, 2017

Related U.S. Application Data
(63) Continuation of application No. PCT/JP2015/072112, filed on Aug. 4, 2015.

(30) Foreign Application Priority Data
Sep. 11, 2014 (JP) 2014-185317

(51) Int. Cl. G06F 3/041; G06F 3/047; G06F 3/044

(52) U.S. Cl. CPC G06F 3/0412; G06F 3/044; G06F 3/047; G06F 2203/04103; G06F 2203/04112

(57) ABSTRACT

A laminate structure has a three-dimensional shape and is provided with an optically transparent region. The laminate structure has a transparent conductive member provided with at least one conductive layer constituted of fine metal wires on a flexible transparent substrate, a wiring formed on the transparent substrate and electrically connected to the conductive layer, and a cover member protecting the transparent conductive member. The three-dimensional shape is constituted of at least a planar portion, a side portion bent continuously to the planar portion, and a side portion continued to the protrusion portion and bent with respect to the side portion, out of the planar portion, the side portion, and the protrusion portion, the planar portion and the side portion are constituted of the cover member and the transparent conductive member, and the protrusion portion is constituted of at least the transparent conductive member, and the wiring is routed to at least the protrusion portion and is connected to a flexible wiring member at the tip of the protrusion portion of the transparent conductive member.

### CROSS-REFERENCE TO RELATED APPLICATIONS

This application is a Continuation of PCT International Application No. PCT/JP2015/072112 filed on Aug. 4, 2015, which claims priority under 35 U.S.C. §119(a) to Japanese Patent Application No. 2014-185317 filed on Sep. 11, 2014. The above application is hereby expressly incorporated by reference, in its entirety, into the present application.

### BACKGROUND OF THE INVENTION

1. Field of the Invention

The present invention relates a laminate structure having a three-dimensional shape, a touch panel having the laminate structure, a display device with a touch panel, and a method of manufacturing the same, and in particular, to a laminate structure, a touch panel, a display device with a touch panel, and a method of manufacturing the same capable of achieving reduction in thickness even in a case where a three-dimensional shape is made and a touch sensor function is provided in a side portion.

2. Description of the Related Art

In recent years, a touch panel is increasingly employed as an input device of a portable electronic apparatus, such as a smartphone or a tablet personal computer (PC). In these apparatuses, high portability, operability, and designability are required. For example, a device having a curved shape can be used in a state of being mounted on a part of a body. Furthermore, for example, an input part is provided not only on a display screen but also on a side surface or in a ridge portion, whereby it is possible to improve operability even in a small apparatus.

If a touch sensor function is applied to an exterior cover of a portable apparatus, it is possible to achieve reduction in the number of parts and to realize reduction in size of a device and improvement of portability. In addition, if the shape of the touch panel is stereoscopically designed freely, it is possible to design a device freely and to manufacture a device having high designability.

However, since a touch panel of the related art has a planar shape and has a limited input surface, in order to realize the above-described function, it is necessary to combine a plurality of input apparatuses, and as a result, since the shape or size of the apparatus is limited, it is difficult to carry out such operation.

In order to realize the above-described function, a technique which three-dimensionally processes a touch panel has been attracting attention. As such a technique, for example, a technique which three-dimensionally deforms the shape of a touch sensor film formed by applying a conductive layer to a flexible polymer film base material using a mold or the like, and then, integrates the touch sensor film with a resin base material, such as a polycarbonate, is known.

In a touch sensor film in which a conductive layer is formed of a thin film of metal oxide, such as an indium tin oxide (ITO) transparent conductive film of the related art, since a crack or disconnection occurs due to processing, it is not suitable for three-dimensional processing. If a conductive film of a type having a mesh structure of fine metal wires is provided, even if deformation, such as bending or stretching, is performed, since disconnection hardly occurs, it is possible to realize three-dimensional processing.

Realization of a cover member shape with a planar portion to be a main touch input surface and a side portion of a touch panel integrated using the processing method described above has been studied. If such a structure can be realized, it is possible to provide a region for performing a touch input even in the side portion in addition to the touch panel planar portion for performing a main touch operation, and to realize an apparatus with high operability or designability. For example, US2013/0300697A describes a portable terminal having a three-dimensional shape in which a main screen on a front surface and a sub-screen in a side portion curved with respect to the front surface are provided. In US2013/0300697A, the sub-screen is also provided with a touch sensor function, icons or the like are displayed on the sub-screen, and an operation of the portable terminal is enabled by a touch on the icons of the sub-screen.

### SUMMARY OF THE INVENTION

In the periphery of an input region of a touch panel, wirings for connecting sensor electrodes for touch detection to an electric circuit for drive control are provided. Because the wirings are not involved in a touch function normally and have a certain degree of wire width in order to decrease a wiring resistance value, the wirings are normally provided in a portion, such as a lower portion of a decorative printing of the touch panel, which is not visually recognized from the outside, from the viewpoint of designability. In this way, since the region where the peripheral wirings are provided is not a region having a specific function, there is a high demand for reducing a space as much as possible from the viewpoint of reduction in size, reduction in thickness, and designability of a product.

Like the portable terminal having a three-dimensional shape disclosed in US2013/0300697A, in a case where the touch sensor function is provided in the side portion, since a peripheral wiring portion is provided in the side portion in the same manner, the thickness of the product increases as a whole, and it is not preferable from the viewpoint of reduction in thickness of a touch panel-mounted product. Furthermore, in US2013/0300697A, the wirings of the peripheral wiring portion are not considered at all. From this, in a touch panel in which a touch input function is provided in a planar portion and a side portion, there is a need to develop a touch panel capable of realizing reduction in thickness in a final product form.

An object of the invention is to eliminate the problems in the related art described above, and to provide a laminate structure, a display device with a touch panel, and a method of manufacturing the same capable of achieving reduction in thickness even in a case where a three-dimensional shape is made and a touch sensor function is provided in a side portion.

In order to attain the above-described object, the invention provides a laminate structure which has a three-dimensional shape and includes an optically transparent region. The laminate structure comprises a transparent conductive member provided with at least one conductive layer constituted of fine metal wires on a flexible transparent substrate, a wiring formed on the transparent substrate and electrically connected to the conductive layer, and a cover member protecting the transparent conductive member. The three-dimensional shape is constituted of at least a planar portion, a side portion bent continuously to the planar portion, and a protrusion portion continued to the side portion and bent with respect to the side portion, out of the planar portion, the side portion, and the protrusion portion, the planar portion and the side portion are constituted of the cover member and the transparent conductive member, and the protrusion portion is constituted of at least the transparent conductive member, and the wiring is routed to at least the protrusion portion and is connected to a flexible wiring member at the tip of the protrusion portion of the transparent conductive member.

It is preferable that the protrusion portion is constituted only of the transparent conductive member.

It is preferable that the protrusion portion is constituted of the cover member and the transparent conductive member.

It is preferable that the side portions are provided on both sides of the planar portion, and the protrusion portion is provided in one side portion.

It is preferable that the protrusion portion faces the planar portion and is provided substantially in parallel with the planar portion.

It is preferable that the laminate structure further comprises an optically transparent pressure sensitive adhesive layer between the transparent conductive member and the cover member.

For example, the wiring member is connected to an external apparatus. It is preferable that the transparent conductive member is provided inside the three-dimensional shape with respect to the cover member. Furthermore, it is preferable that the conductive layer has a conductive pattern having a mesh structure constituted of the fine metal wires.

For example, the conductive layers are formed on both surfaces of the transparent substrate. Furthermore, for example, the conductive layer is formed on one surface of the transparent substrate, and two transparent substrates on which the conductive layer is formed on one surface are laminated.

The invention provides a display device comprising: a touch panel; and a display module. The touch panel includes a laminate structure which has a three-dimensional shape and includes an optically transparent region. The laminate structure includes a transparent conductive member provided with at least one conductive layer constituted of fine metal wires on a flexible transparent substrate, a wiring formed on the transparent substrate and electrically connected to the conductive layer, and a cover member protecting the transparent conductive member. The three-dimensional shape is constituted of at least a planar portion, a side portion bent continuously to the planar portion, and a protrusion portion continued to the side portion and bent with respect to the side portion, out of the planar portion, the side portion, and the protrusion portion, the planar portion and the side portion are constituted of the cover member and the transparent conductive member, and the protrusion portion is constituted of at least the transparent conductive member, and the wiring is routed to at least the protrusion portion and is connected to a flexible wiring member at the tip of the protrusion portion of the transparent conductive member. The display module is housed in a recess portion constituted of the planar portion, the side portion, and the protrusion portion of the laminate structure

It is preferable that a projection for positioning the display module is provided in the protrusion portion.

The invention also provides a method of manufacturing a display device with a touch panel having the laminate structure of the invention comprising a step of obtaining a laminate structure having a three-dimensional shape constituted of the planar portion, the side portion formed to be bent continuously to the planar portion, and the protrusion portion continued to the side portion and bent with respect to the side portion, and a step of mounting a display module in a recess portion constituted of the planar portion, the side portion, and the protrusion portion.

For example, the protrusion portion is constituted of the transparent conductive member or the cover member and the transparent conductive member.

For example, the display module is mounted while sliding with respect to the recess portion.

According to the invention, it is possible to provide a laminate structure, a display device with a touch panel, and a method of manufacturing the same capable of achieving reduction in thickness even in a case where a three-dimensional shape is made and a touch sensor function is provided in a side portion.

### BRIEF DESCRIPTION OF THE DRAWINGS

FIG. 1 is a schematic perspective view showing a display device with a touch panel having a laminate structure according to an embodiment of the invention.

FIG. 2A is a schematic sectional view of a main part of the display device with a touch panel shown in FIG. 1, and FIG. 2B is a schematic sectional view of a main part of another example of the display device with a touch panel according to the embodiment of the invention.

FIG. 3A is a schematic view showing a laminate of a laminate structure according to the embodiment of the invention, FIG. 3B is a schematic sectional view showing an example of a transparent conductive member, and FIG. 3C is a schematic view showing a modification example of an example of the laminate of the laminate structure according to the embodiment of the invention.

FIG. 4A is a schematic view showing another example of the laminate of the laminate structure according to the embodiment of the invention, FIG. 4B is a schematic sectional view showing another example of a transparent conductive member, and FIG. 4C is a schematic view showing a modification example of the laminate of the laminate structure according to the embodiment of the invention.

FIG. 5 is a schematic view showing an example of the arrangement of first conductive layers and first wirings in the laminate of the laminate structure according to the embodiment of the invention.

FIG. 6 is a schematic view showing another example of the arrangement of the first conductive layers and the first wirings in the laminate of the laminate structure according to the embodiment of the invention.

FIG. 7 is a schematic view showing another example of the arrangement of the first conductive layers and the first wirings in the laminate of the laminate structure according to the embodiment of the invention.

FIG. 8 is a schematic view showing an example of the arrangement of second conductive layers and second wirings in the laminate of the laminate structure according to the embodiment of the invention.

FIG. 9 is a schematic view showing another example of the arrangement of the second conductive layers and the second wirings in the laminate of the laminate structure according to the embodiment of the invention.

FIG. 10 is a schematic view showing an example of a first conductive pattern of the first conductive layers in the laminate of the laminate structure according to the embodiment of the invention.

FIG. 11 is a schematic view showing an example of a second conductive pattern of the second conductive layers in the laminate of the laminate structure according to the embodiment of the invention.

FIG. 12 is a schematic view showing a combination pattern obtained by arranging the first conductive pattern and the second conductive pattern to face each other in the laminate of the laminate structure according to the embodiment of the invention.

FIGS. 13A to 13C are schematic views showing a first example of a method of manufacturing a display device with a touch panel according to the embodiment of the invention in a process order.

FIGS. 14A to 14C are schematic views showing a second example of the method of manufacturing a display device with a touch panel according to the embodiment of the invention in a process order.

FIGS. 15A and 15B are schematic views showing a third example of the method of manufacturing a display device with a touch panel according to the embodiment of the invention in a process order.

### DESCRIPTION OF THE PREFERRED EMBODIMENTS

Hereinafter, a laminate structure, a touch panel, a display device with a touch panel, and a method of manufacturing the same of the invention will be described in detail based on a preferred embodiment shown in the accompanying drawings. It should be noted that the invention is not limited to the following embodiment.

In the following description, “to” indicating a numerical value range includes numerical values described on both sides. For example, when ε is a numerical value α to a numerical value β, the range of ε is a range including the numerical value α and the numerical value β, and is represented as α≦ε≦β using mathematical symbols.

The term “transparent” means that light transmittance is at least equal to or greater than 60% at a visible light wavelength (wavelength 400 nm to 800 nm), preferably, equal to or greater than 80%, more preferably, equal to or greater than 90%, and still more preferably, equal to or greater than 95%.

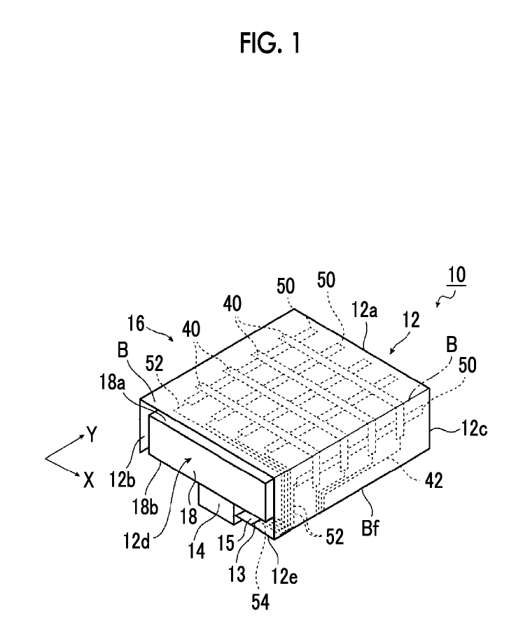

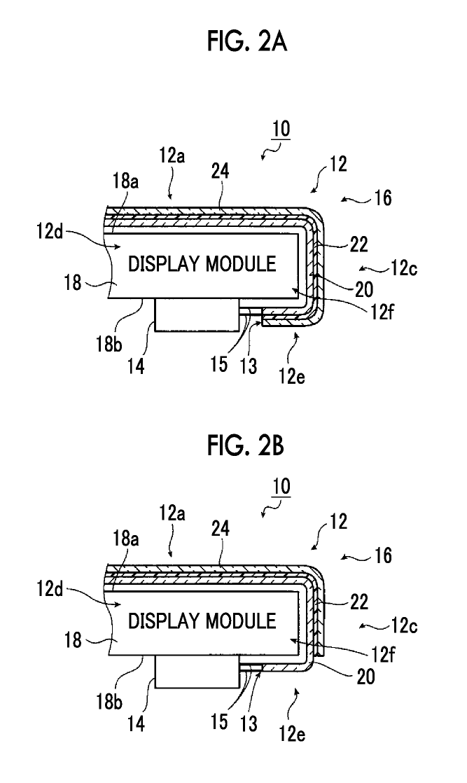

FIG. 1 is a schematic perspective view showing a display device with a touch panel having a laminate structure according to an embodiment of the invention. FIG. 2A is a schematic sectional view of a main part of the display device with the touch panel shown in FIG. 1, and FIG. 2B is a schematic sectional view of a main part of another example of the display device with a touch panel according to the embodiment of the invention.

The laminate structure of the invention can be used in, for example, a touch panel. As a specific example, for example, a display device 10 with a touch panel having a laminate structure 12 shown in FIG. 1 will be described.

The display device 10 with a touch panel shown in FIG. 1 has a laminate structure 12, a controller 14, and a display module 18, and the laminate structure 12 and the controller 14 are connected by a flexible wiring member, for example, a flexible circuit board 15 (hereinafter, referred to as FPC 15).

The display module 18 has a function of displaying an image including a motion image or the like on a screen, and the configuration thereof is not particularly limited and has, for example, has a liquid crystal display, an organic EL device, an electronic paper, or the like. In the display module 18, for example, an image is displayed on a display surface 18a.

If the display device 10 with a touch panel is touched with a finger or the like, change in capacitance occurs at the touched position, the change in capacitance is detected by the controller 14, and the coordinates of the touched position are specified. The controller 14 is an external apparatus of the laminate structure 12, and is constituted of a known controller which is used for detection on the touch panel. If the touch panel is a capacitance type, a capacitance type controller can be suitably used, and if the touch panel is a resistive film type, a resistive film type controller can be suitably used.

The laminate structure 12 has a laminate 20, a cover member 24, and the FPC 15, and has a three-dimensional shape. The laminate 20 is provided inside the three-dimensional shape with respect to the cover member 24.

The laminate structure 12 comprises at least a planar portion 12a, two side portions 12b and 12c formed continuously to the planar portion 12a, and a protrusion portion 12e formed continuously to one side portion 12c. The two side portions 12b and 12c are formed by bending both end portions of the planar portion 12a. Portions where the planar portion 12a is bent are referred to as bending portions B. The protrusion portion 12e is formed by bending the end of the side portion 12c. A portion where the side portion 12c is bent is referred to as a bending portion Bf.

In the laminate structure 12, the side portions 12b and 12c are constituted of planes nearly at right angles to the planar portion 12a, the protrusion portion 12e is constituted of a plane nearly at right angles to the side portion 12c and is a plane nearly parallel to the planar portion 12a. The protrusion portion 12e faces the planar portion 12a.

The side portions 12b and 12c are not limited to planes nearly at right angles to the planar portion 12a, and the side portions 12b and 12c may be constituted of curved surfaces.

Although the protrusion portion 12e is not provided in the side portion 12b, the invention is not limited thereto, and the protrusion portion 12e may be provided in the side portion 12b.

The display module 18 is provided in a recess portion 12d constituted of the planar portion 12a, the side portions 12b and 12c, and the protrusion portion 12e of the laminate structure 12 such that the display surface 18a turns toward the planar portion 12a, and the end of the display module 18 is inserted into a region 12f surrounded by the planar portion 12a, the side portion 12c, and the protrusion portion 12e. The protrusion portion 12e extends downward around a rear surface 18b of the display module 18. The controller 14 is provided on the rear surface 18b of the display module 18.

The laminate structure 12 is provided with an optically transparent region in order to allow an image displayed on the display module 18 to be recognized. In this case, in the laminate 20 and the cover member 24 of the laminate structure 12, the planar portion 12a and the side portions 12b and 12c are made transparent suitably according to the range of the display surface 18a such that an image including a motion image or the like displayed on the display surface 18a is recognizable.

The display module 18 can be attached to the laminate structure 12 by attaching an optically transparent pressure sensitive adhesive (OCA) or optically transparent resin (OCR) described below to the display surface 18a. The display module 18 may be attached to the laminate structure 12 without using an optically transparent pressure sensitive adhesive (OCA) or optically transparent resin (OCR). In this case, a structure called an air gap is formed.

Since the end of the display module 18 is inserted into the region 12f, it is preferable that a projection (not shown) or the like for position alignment of the display module 18 is provided in the protrusion portion 12e. For position alignment of the display module 18, an engagement projection (not shown) for engagement of the rear surface 18b and the protrusion portion 12e, for example, a recess portion (not shown) and a projection portion (not shown) may be provided.

The laminate 20 of the laminate structure 12 has a three-dimensional shape corresponding to the planar portion 12a, the side portions 12b and 12c, and the protrusion portion 12e. As shown in FIG. 2A, the laminate 20 is attached to the rear surface of the cover member 24, for example, by an optically transparent adhesive layer 22. In the laminate structure 12, all of the planar portion 12a, the side portions 12b and 12c, and the protrusion portion 12e are constituted of the laminate 20 and the cover member 24.

The adhesive layer 22 is optically transparent, and is not particularly limited as long as the laminate 20 can be attached to the cover member 24. For example, an optically transparent pressure sensitive adhesive (OCA) or optically transparent resin (OCR), such as UV curable resin, can be used. If the laminate 20 and the cover member 24 can be directly attached to each other, the adhesive layer 22 is not necessarily provided.

The cover member 24 protects the laminate 20, and is constituted of, for example, a resin material, such as polycarbonate.

An X direction and a Y direction shown in FIG. 1 are orthogonal to each other. As shown in FIG. 1, in the laminate structure 12, a plurality of first conductive layers 40 extending in the X direction are provided at intervals in the Y direction. The first conductive layers 40 are provided in the planar portion 12a and the side portions 12b and 12c, and extend over the side portions 12b and 12c. A plurality of second conductive layers 50 extending in the Y direction are provided at intervals in the X direction. The second conductive layers 50 are provided in the planar portion 12a, the side portion 12b, and the side portion 12c. With this, it is possible to provide the side portions 12b and 12c with a touch sensor function.

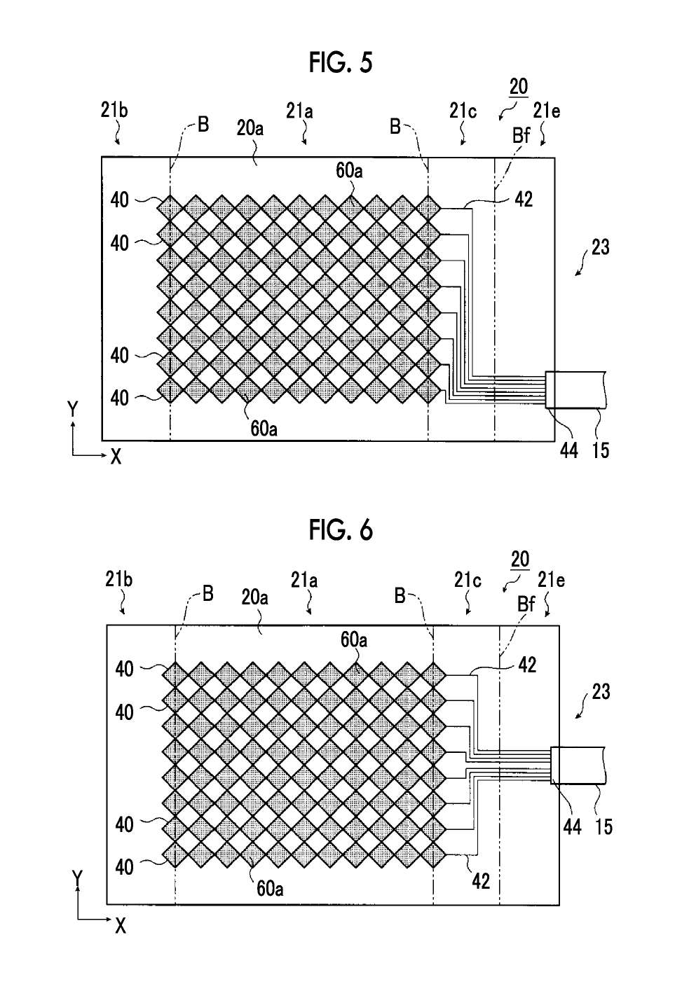

The respective first conductive layers 40 are electrically connected to terminal portions (not shown) at one end thereof. In addition, the respective terminal portions are electrically connected to first wirings 42. The respective first wirings 42 are routed to one side portion 12c out of the two side portions 12b and 12c, are further routed to a tip 13 of the protrusion portion 12e, and are integrated and connected to a terminal 44 (see FIG. 5) provided at the tip 13. The FPC 15 (see FIG. 5) provided at the tip 13 is connected to the terminal 44 (see FIG. 5), and the FPC 15 is connected to the controller 14.

The respective second conductive layers 50 are electrically connected to terminal portions (not shown) at one end thereof. The respective terminal portions are electrically connected to conductive second wirings 52. The respective second wirings 52 are routed to one side portion 12c, are further routed to the tip 13 of the protrusion portion 12e, and are integrated and connected to a terminal 54 provided at the tip 13. The FPC 15 provided at the tip 13 is connected to the terminal 54, and the FPC 15 is connected to the controller 14. The first conductive layers 40, the first wirings 42, and the terminal 44, and the second conductive layers 50, the second wirings 52, and the terminal 54 will be described below in detail.

The laminate structure 12 and the controller 14 constitute a touch panel 16.

The display module 18 has the display surface 18a corresponding to the planar portion 12a, and has no function of displaying an image on the side surface. In this case, while an image is not displayed in the side portions 12b and 12c, the side portions 12b and 12c can be used as, for example, a touch switch for powering on and off. If the display module 18 has a function of displaying an image on the side surface, icons or the like are displayed, and the icons and the functions are associated with each other, whereby it is possible to enable various operations of an apparatus as the display device 10 with a touch panel.

The first wirings 42 of the first conductive layers 40 and the second wirings 52 of the second conductive layers 50 are respectively routed to the tip 13 of the protrusion portion 12e by way of the side portion 12c, and the peripheral wirings of the first wirings 42 and the second wirings 52 are integrated, whereby the thickness of the laminate structure 12 can be made corresponding to the length of the side portion 12c in the extension direction of the first conductive layers 40, and thus, it is possible to achieve reduction in thickness. With this, it is possible to achieve reduction in thickness even in the display device 10 with a touch panel which has a three-dimensional shape and provides the side portions 12b and 12c with a touch sensor function.

For example, in a case of leading the second wirings 52 of the second conductive layers 50 from the longitudinal direction of the second conductive layers 50, the terminal portions need to be provided in the planar portion 12a, and accordingly, the terminal portions need to be hidden in appearance. For this reason, the region of the decorative printing increases and design is restricted. In contrast, in the invention, the peripheral wirings are concentrated on one side portion 12c side, design is not restricted. Furthermore, in a case where the terminal portions are provided in the planar portion 12a, while a space for attaching the FPC is required, the peripheral wirings are concentrated, whereby it is possible to make such a space unnecessary.

The wiring path or the like of the peripheral wirings is not particularly limited as long as the peripheral wirings of the first wirings 42 and the second wirings 52 are at least routed to the protrusion portion 12e and connected to the FPC at the tip 13 of the protrusion portion 12e.

Since the first conductive layers 40 extending over the side portions 12b and 12c are hardly detected correctly, and adjustment for detection becomes complicated, the first wirings 42 are provided as short as possible, whereby it is possible to obtain the laminate structure 12 unsusceptible to noise and the display device 10 with a touch panel having the laminate structure 12. The protrusion portion 12e is provided, whereby it is possible to shorten the wiring distance of the FPC 15 to the controller 14. With this, a connection wiring portion becomes unsusceptible to electric noise, and it is possible to reduce the occurrence frequency of an operation fault of the display device 10 with a touch panel.

In the laminate structure 12 shown in FIGS. 1 and 2A, although the cover member 24 is provided to the protrusion portion 12e, and the protrusion portion 12e is constituted of the laminate 20 and the cover member 24, the invention is not limited thereto. As shown in FIG. 2B, the cover member 24 may not be provided in the protrusion portion 12e, and the protrusion portion 12e may be constituted only by the laminate 20. With this configuration, the protrusion portion 12e is not required in the cover member 24, and compared to FIG. 2A, it is possible to simply the shape and to facilitate molding.

Next, the laminate 20 constituting the laminate structure 12 will be described.

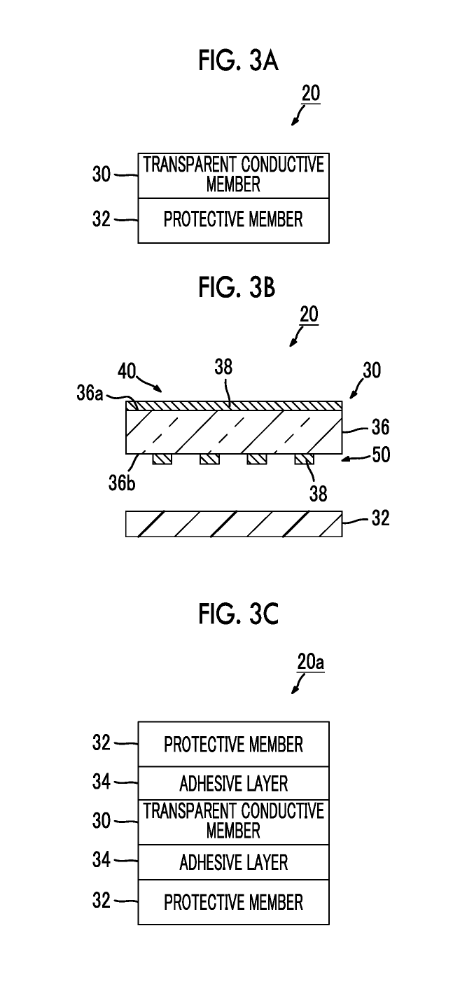

FIG. 3A is a schematic view showing the laminate of the laminate structure according to the embodiment of the invention, and FIG. 3B is a schematic sectional view showing an example of a transparent conductive member. The laminate 20 has a three-dimensional shape like the laminate structure 12, and in FIGS. 3A and 3B, in order to show the configuration of the laminate 20, the laminate 20 is shown in a planar shape.

The laminate 20 is constituted, for example, by laminating a protective member 32 and a transparent conductive member 30 in this order from below.

The transparent conductive member 30 corresponds to a touch sensor portion of the display device 10 with a touch panel. The transparent conductive member 30 has a plurality of conductive layers constituted of conductive fine metal wires 38 (see FIG. 3B) on both surfaces of a flexible transparent substrate 36 (see FIG. 3B).

In the transparent conductive member 30, as shown in FIG. 3B, the first conductive layers 40 constituted of the fine metal wires 38 are formed on a front surface 36a of the transparent substrate 36, and the second conductive layers 50 constituted of the fine metal wires 38 are formed on a rear surface 36b of the transparent substrate 36. In the transparent conductive member 30, the first conductive layers 40 and the second conductive layers 50 are arranged to face each other and to be orthogonal to each other in a plan view. The first conductive layers 40 and the second conductive layers 50 are to detect a touch. The conductive patterns of the first conductive layers 40 and the second conductive layers 50 are not particularly limited, and may be bar-shaped or may have a mesh structure, and an example of the conductive pattern will be described below.

The first conductive layers 40 and the second conductive layers 50 are respectively formed on the front surface 36a and the rear surface 36b of one transparent substrate 36, whereby it is possible to reduce deviation in the positional relationship between the first conductive layers 40 and the second conductive layers 50 even if the transparent substrate 36 shrinks.

Though not shown, the first wirings 42 which are connected to the first conductive layers 40 and the terminal 44 to which the first wirings 42 are connected are formed on the front surface 36a of the transparent substrate 36.

Though not shown, the second wirings 52 which are connected to the second conductive layers 50 and the terminal 54 to which the second wirings 52 are connected are formed on the rear surface 36b of the transparent substrate 36.

The protective member 32 is to protect the transparent conductive member 30, and in particular, any conductive layer, and for example, is provided to be brought into contact with the second conductive layers 50. The protective member 32 has the same three-dimensional shape as the laminate structure 12. The configuration of the protective member 32 is not particularly limited as long as the protective member can protect the transparent conductive member 30, and in particular, any conductive layer. For example, glass, polycarbonate (PC), polyethylene terephthalate (PET), or the like can be used.

The protective member 32 may serve as a touch surface of the touch panel. In this case, the protective member 32 performs the function of the above-described cover member 24, and the cover member 24 is not required. At least one of a hard coat layer or an antireflection layer may be provided on the front surface of the protective member 32.

The laminate 20 shown in FIGS. 3A and 3B has a configuration of the protective member 32/the second conductive layer 50/the transparent substrate 36/the first conductive layer 40. The transparent conductive member 30 is constituted of the second conductive layer 50/the transparent substrate 36/the first conductive layer 40. For example, the transparent conductive member 30 and the protective member 32 may constitute the planar portion 12a, the side portions 12b and 12c, and the protrusion portion 12e of the laminate structure 12. Furthermore, the transparent conductive member 30 and the protective member 32 may constitute the planar portion 12a and the side portions 12b and 12c of the laminate structure 12, and the transparent conductive member 30 may constitute the protrusion portion 12e.

The transparent substrate 36 has flexibility and electric insulation. The transparent substrate 36 supports the first conductive layers 40 and the second conductive layers 50. As the transparent substrate 36, for example, a plastic film, a plastic plate, a glass plate, or the like can be used. The plastic film and the plastic plate can be made of, for example, polyesters, such as polyethylene terephthalate (PET) or polyethylene naphthalate (PEN), polyolefins, such as polyethylene (PE), polypropylene (PP), polystyrene, ethylene vinyl acetate (EVA), cycloolefin polymer (COP), or cycloolefin copolymer (COC), vinyl-based resin, polycarbonate (PC), polyamide, polyimide, acrylic resin, triacetylcellulose (TAC), or the like. From the viewpoint of light transmittance, heat shrinkability, processability, and the like, it is preferable that the plastic film and the plastic plate are made of polyethylene terephthalate (PET).

The fine metal wires 38 constituting the first conductive layers 40 and the second conductive layers 50 are not particularly limited, and are formed of, for example, ITO, Au, Ag, or Cu. The fine metal wires 38 may be made of ITO, Au, Ag, or Cu and binder. The fine metal wires 38 contain the binder, whereby bending processing gets easier and bending resistance is improved. For this reason, it is preferable that the first conductive layers 40 and the second conductive layers 50 are made of a conductor containing a binder. As the binder, a binder which is used for a wiring of a conductive film can be suitably used, and for example, a binder described in JP2013-149236A can be used.

If the first conductive layers 40 and the second conductive layers 50 are formed of mesh electrodes having a mesh shape in which the fine metal wires 38 intersect each other, it is possible to reduce resistance, to suppress disconnection during molding in a three-dimensional shape, and to reduce the influence of the resistance value even if disconnection occurs.

The wire width of the fine metal wires 38 is not particularly limited, and preferably, is equal to or less than 30 μm, more preferably, equal to or less than 15 μm, still more preferably, equal to or less than 10 μm, particularly preferably, equal to or less than 7 μm, and most preferably, equal to or less than 4 μm, and preferably, is equal to or greater than 0.5 μm, and more preferably, equal to or greater than 1.0 μm. If the wire width is within the above-described range, the first conductive layers 40 and the second conductive layers 50 can be formed to have low resistance comparatively easily.

In a case where the fine metal wires 38 are applied as a peripheral wiring (lead wiring) in a conductive film for a touch panel), the wire width of the fine metal wires 38 is preferably equal to or less than 500 μm, more preferably, equal to or less than 50 μm, and particularly preferably, equal to or less than 30 μm. If the wire width is within the above-described range, the touch panel electrodes having low resistance can be comparatively easily formed.

In a case where the fine metal wires 38 are applied as a peripheral wiring in a conductive film for a touch panel, the peripheral wiring in the conductive film for a touch panel may be formed of a mesh pattern electrode, and in this case, a preferable wire width is the same as the preferable wire width of the fine metal wires 38 employed in the above-described conductive layers.

The thickness of the fine metal wires 38 is not particularly limited, and preferably, is 0.01 μm to 200 μm, more preferably, equal to or less than 30 μm, still more preferably, equal to or less than 20 μm, particularly preferably, 0.01 μm to 9 μm, and most preferably, 0.05 μm to 5 μm. If the thickness is within the above-described range, it is possible to comparatively form the touch panel electrodes having low resistance and excellent durability.

A method of forming the first conductive layers 40 and the second conductive layers 50 is not particularly limited. For example, the conductive layers can be formed by exposing and developing a photosensitive material having an emulsion layer containing photosensitive silver halide salt. Furthermore, the first conductive layers 40 and the second conductive layers 50 can be formed by forming metal foils on the transparent substrate 36 and printing resist on the respective metal foils in a pattern shape, or by patterning resist coated on the entire surface through exposure and development and etching metal in an opening. In addition, as the method of forming the first conductive layers 40 and the second conductive layers 50, a method which prints paste containing fine particles of the material constituting the conductor described above and performs metal plating on the paste, and a method which uses an ink jet method using ink containing fine particles of the material constituting the conductor described above are exemplified.

The terminal portions (not shown), the first wirings 42, the terminal 44, the second wirings 52, and the terminal 54 can be formed, for example, by the method of forming the fine metal wires 38 described above.

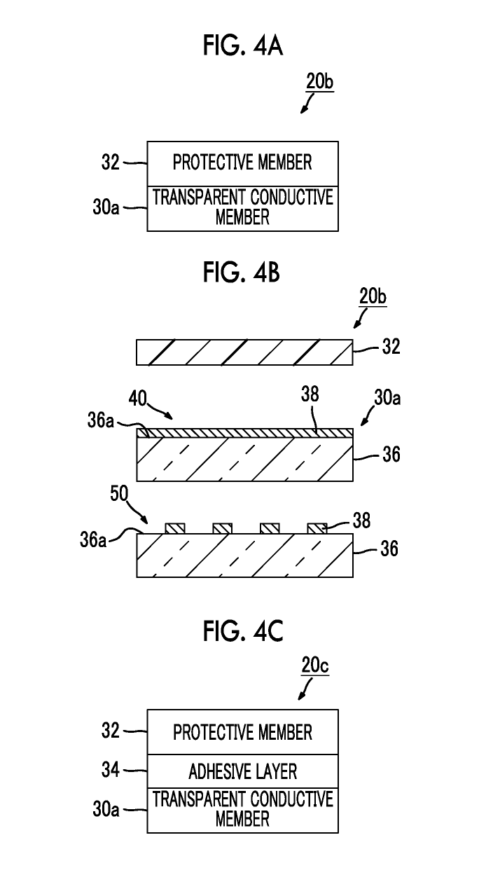

The invention is not limited to the configuration of the laminate 20 shown in FIGS. 3A and 3B, and for example, a laminate 20a shown in FIG. 3C or a laminate 20b shown in FIGS. 4A and 4B may be applied.

FIG. 3C is a schematic view showing a modification example of an example of the laminate of the laminate structure according to the embodiment of the invention, FIG. 4A is a schematic view showing another example of the laminate of the laminate structure according to the embodiment of the invention, and FIG. 4B is a schematic sectional view showing another example of the transparent conductive member.

Although the laminate 20a and the laminate 20b constitute the laminate structure 12 and have a three-dimensional shape like the laminate structure 12, like the laminate 20, in FIGS. 3C, and 4A and 4B, in order to show the configurations of the laminates 20a and 20b, the laminates 20a and 20b are shown in a planar shape.

The laminate 20a shown in FIG. 3C is different from the laminate 20 shown in FIG. 3A in that an adhesive layer 34 is provided between the protective member 32 and the transparent conductive member 30, and the protective member 32, the adhesive layer 34, the transparent conductive member 30, and the adhesive layer 34, and the protective member 32 are laminated in this order from below. Other configurations are the same as those of the laminate 20 shown in FIGS. 3A and 3B, and thus, detailed description thereof will not be repeated.

The adhesive layer 34 is to bond the protective member 32 to the transparent conductive member 30, and is constituted of an optically transparent adhesive layer. The adhesive layer 34 is not particularly limited as long as the adhesive layer is optically transparent and can bond the protective member 32 to the transparent conductive member 30. For example, an optically transparent pressure sensitive adhesive (OCA) or optically transparent resin (OCR), such as ultraviolet (UV) curable resin, can be used. The term “optically transparent” is the same as the definition of the term “transparent” described above.

The form of the adhesive layer 34 is not particularly limited, and the adhesive layer 34 may be formed by coating an adhesive or an adhesive sheet may be used.

The laminate 20b shown in FIGS. 4A and 4B is different from the laminate 20 shown in FIGS. 3A and 3B in view of the configuration of a transparent conductive member 30a. Other configurations are the same as those of the laminate 20 shown in FIGS. 3A and 3B, and thus, detailed description thereof will not be repeated.

As shown in FIG. 4B, in a transparent conductive member 30a, the first conductive layers 40 constituted of the fine metal wires 38 are formed on the front surface 36a of the transparent substrate 36, and the second conductive layers 50 constituted of the fine metal wires 38 are formed on a front surface 36a of another transparent substrate 36. The transparent conductive member 30a is formed by arranging an optically transparent adhesive layer (not shown) on the second conductive layers 50 and laminating the two transparent substrates 36. In this way, the conductive layers may be formed on each transparent substrate 36, and the respective transparent substrates 36 may be laminated.

The laminate 20b may have the configuration of a laminate 20c shown in FIG. 4C. FIG. 4C is a schematic view showing another modification example of the laminate of the laminate structure according to the embodiment of the invention.

The laminate 20c has the same configuration as the laminate 20b shown in FIGS. 4A and 4B, excluding that an adhesive layer 34 is provided between the transparent conductive member 30a and the protective member 32, and thus, detailed description thereof will not be repeated. The adhesive layer 34 of the laminate 20c has the same configuration as the adhesive layer 34 of the laminate 20a shown in FIG. 3C, and thus, detailed description thereof will not be repeated.

In regards to all of the transparent conductive member 30 of the laminate 20a described above and the transparent conductive members 30a of the laminates 20b and 20c described above, for example, the transparent conductive member 30 and the protective member 32 may constitute the planar portion 12a, the side portions 12b and 12c, and the protrusion portion 12e of the laminate structure 12, or the transparent conductive member 30 and the protective member 32 may constitute the planar portion 12a and the side portions 12b and 12c of the laminate structure 12, and the transparent conductive member 30 may constitute the protrusion portion 12e.

All of the transparent conductive members 30 of the laminates 20 and 20a and the transparent conductive members 30a of the laminates 20b and 20c may protrude from the protective member 32. If the adhesive layer 34 is provided, the transparent conductive member may protrude from the protective member 32 and the adhesive layer 34. With this, it is possible to facilitate connection of the FPC 15 to the terminal 44 and the terminal 54.

Next, the arrangement of the first conductive layers 40, the first wirings 42, the terminal 44, and the FPC 15 will be described.

FIG. 5 is a schematic view showing an example of the arrangement of first conductive layers and first wirings in the laminate of the laminate structure according to the embodiment of the invention. As described above, although the laminate 20 has a three-dimensional shape, in FIG. 5, the laminate 20 constituting the laminate structure 12 is shown in a plan view. In the laminate 20 shown in FIG. 5, a region 21a sandwiched between two bending portions B corresponds to the planar portion 12a of the laminate structure 12, regions 21b and 21c outside the bending portions B correspond to the side portions 12b and 12c of the laminate structure 12, and a region 21e outside the bending portion Bf corresponds to the protrusion portion 12e.

As shown in FIG. 5, a plurality of first conductive layers 40 extending in the X direction are provided in parallel in the Y direction. The first conductive layers 40 are also provided in the regions 21b and 21c outside the bending portions B, and the first conductive layers 40 are provided in the side portions 12b and 12c.

The first wirings 42 are electrically connected to the respective first conductive layers 40 through terminal portions (not shown) in the region 21c corresponding to the side portion 12c.

The first wirings 42 are respectively routed to the region 21c and the region 21e, are routed to a tip 23 of the region 21e, and are connected to a terminal 44 provided at the tip 23 of the region 21e. The FPC 15 is connected to the terminal 44. The tip 23 of the region 21e corresponds to the tip 13 of the protrusion portion 12e.

The first conductive layers 40 are provided in the region 21c corresponding to the side portion 12c, and the first wirings 42 of the first conductive layers 40 are routed from the region 21c to the region 21e. For this reason, as described above, the length of the region 21c in the X direction can be made corresponding to the length of the side portion 12c, that is, the thickness of the laminate structure 12, and thus, it is possible to achieve reduction in thickness of the laminate structure 12 and the display device 10 with a touch panel.

Since the first conductive layers 40 are provided across the bending portions B, and the first conductive layers 40 are bent, sensing of the first conductive layers 40 across the bending portions B is difficult, and in order to allow sensing, it is necessary to minimize other kinds of noise. However, the first wirings 42 are concentrated on the tip 23 of the region 21e corresponding to the tip 13 of the protrusion portion 12e, whereby it is possible to shorten the length of the first wirings 42. With this, it is possible to reduce noise and to facilitate sensing of the first conductive layers 40 across the bending portions B. In a case of concentrating the first wirings 42 on the tip 23 of the region 21e corresponding to the tip 13 of the protrusion portion 12e, it is preferable to concentrate 90% or more of a plurality of first wirings 42.

The first wirings 42 are concentrated on the protrusion portion 12e, and the FPC 15 is provided at the tip 13 of the protrusion portion 12e, whereby it is possible to shorten the wiring distance to the controller 14. With this, it is possible to suppress the influence of noise.

A form of routing the first wirings 42 is not limited to that shown in FIG. 5.

FIG. 6 is a schematic view showing another example of the arrangement of the first conductive layers and the first wirings in the laminate of the laminate structure according to the embodiment of the invention. FIG. 6 shows a laminate 20 in a plan view like FIG. 5. In the laminate 20 shown in FIG. 6, the same components as those of the laminate 20 shown in FIG. 5 are represented by the same reference numerals, and detailed description thereof will not be repeated.

Like the laminate 20 shown in FIG. 6, the terminal 44 may be provided at the tip 23 of the region 21e corresponding to the tip 13 of the protrusion portion 12e and at the center in the Y direction. In this case, it is possible to make the length in the X direction of the region 21c corresponding to the side portion 12c shorter than that of the laminate 20 shown in FIG. 5. With this, it is possible to achieve further reduction in thickness of the laminate structure 12 and the display device 10 with a touch panel.

It is possible to make the total length of the first wirings 42 shorter than the laminate 20 shown in FIG. 5. With this, it is possible to reduce noise and to further facilitate sensing of the first conductive layers 40 across the bending portion B. Even in the laminate 20 of FIG. 6, it is possible to make the FPC 15 as short as the laminate 20 shown in FIG. 5, and to thus reduce the influence of noise.

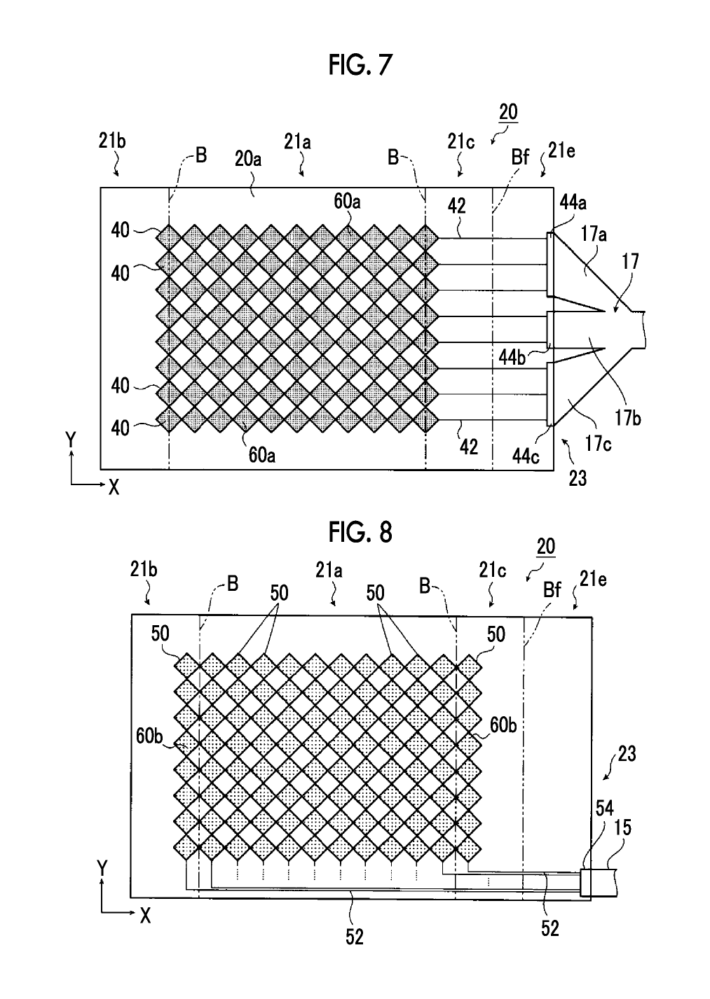

In addition, a form of routing the first wirings 42 may have a configuration shown in FIG. 7.

FIG. 7 is a schematic view showing another example of the arrangement of the first conductive layers and the first wirings in the laminate of the laminate structure according to the embodiment of the invention. FIG. 7 shows a laminate 20 in a plan view like FIG. 5. In the laminate 20 shown in FIG. 7, the same components as those of the laminate 20 shown in FIG. 5 are represented by the same reference numerals, and detailed description thereof will not be repeated.

Like the laminate 20 shown in FIG. 7, three terminals including a first terminal 44a, second terminal 44b, and a third terminal 44c may be provided at the tip 23 of the region 21e corresponding to the tip 13 of the protrusion portion 12e and at positions at regular intervals in the Y direction. In this case, the first wirings 42 of three first conductive layers 40 are connected to the first terminal 44a, the first wirings 42 of two first conductive layers 40 are connected to the second terminal 44b, and the first wirings 42 of three first conductive layers 40 are connected to the third terminal 44c. While the number of terminals and the number of connections of the first wirings 42 of the first conductive layers 40 to each terminal are not particularly limited, it is preferable that the number of connections to each terminal is identical, and the first wirings 42 have the same length. With this, it is possible to achieve uniformity of wiring resistance, and for example, to reduce variation in sensing characteristics.

In a case where a plurality of terminals are provided, it is preferable to use an FPC which is a single wiring member and has, for example, branch portions corresponding to the number of a plurality of terminals. With this, even if there are a plurality of terminals, it should suffice that the controller 14 and one FPC 15 are connected, and the connection to the controller 14 is not complicated. For this reason, for example, an FPC 17 having three branch portions 17a, 17b, and 17c is used. In this case, the branch portion 17a of the FPC 17 is connected to the first terminal 44a, the branch portion 17b is connected to the second terminal 44b, and the branch portion 17c is connected to the third terminal 44c.

Even in the form of routing the first wirings 42 shown in FIG. 7, it is possible to make the length in the X direction of the region 21c corresponding to the side portion 12c shorter than that of the laminate 20 shown in FIG. 5. With this, it is possible to achieve further reduction in thickness of the laminate structure 12 and the display device 10 with a touch panel.

It is possible to make the total length of the first wirings 42 shorter than the laminate 20 shown in FIG. 5, and with this, it is possible to reduce noise, and to further facilitate sensing of the first conductive layers 40 across the bending portion B. Even in the laminate 20 of FIG. 7, it is possible to make the FPC 17 as short as the laminate 20 shown in FIG. 5, and thus, it is possible to reduce the influence of noise.

The FPCs 15 may be respectively connected to the first terminal 44a, the second terminal 44b, and the third terminal 44c.

Next, the arrangement of the second conductive layers 50, the second wirings 52, the terminal 54, and the FPC 15 will be described.

FIG. 8 is a schematic view showing an example of the arrangement of second conductive layers and second wirings in the laminate of the laminate structure according to the embodiment of the invention. FIG. 8 shows a laminate 20 in a plan view like FIG. 5. In the laminate 20 shown in FIG. 8, the same components as those of the laminate 20 shown in FIG. 5 are represented by the same reference numerals, and detailed description thereof will not be repeated.

As shown in FIG. 8, a plurality of second conductive layers 50 extending in the Y direction are provided in parallel in the X direction. The second conductive layers 50 are also provided in the regions 21b and 21c outside the bending portions B, and the second conductive layers 50 are provided in the side portions 12b and 12c. With this, sensing in the side portions 12b and 12c becomes possible.

The second wirings 52 are electrically connected to the respective second conductive layers 50 through terminal portions (not shown). The respective second wirings 52 are routed and are connected to the terminal 54 provided at the tip 23 of the region 21e corresponding to the tip 13 of the protrusion portion 12e by way of the region 21c corresponding to the side portion 12c. The FPC 15 is connected to the terminal 54.

The second wirings 52 are led from one end in the Y direction and are routed to the region 21e by way of the region 21c, the second wirings 52 are concentrated on the region 21e, and the FPC 15 is provided at the tip 23 of the region 21e, whereby it is possible to simplify the configuration compared to a case where a terminal is provided at one end of the region 21a in the Y direction and an FPC is connected to the terminal. Since no terminal is provided in the region 21a, it is possible to make the region of the decorative printing for hiding the terminal small.

The second wirings 52 are concentrated on the region 21e and the FPC 15 is provided at the tip 23 of the region 21e, whereby it is possible to shorten the wiring distance of the FPC 15 to the controller 14. With this, it is possible to suppress the influence of noise. While the second wirings 52 may be routed to both of the region 21b and the region 21c, in this case, the number of FPCs increases, and the total length of the wiring distance of the FPCs becomes longer than when one FPC is provided. Since the FPC is susceptible to noise, it is preferable that the wiring distance is short. If the number of connections between the controller 14 and the FPC increases, the configuration of the controller 14 becomes complicated. In addition, since it is necessary to take the influence of noise at the connection location of the controller 14 and the FPC 15 into consideration, the number of FPCs provided for each of the first conductive layers 40 and the second conductive layers 50 needs to be one, and the wiring distance needs to be shortened.

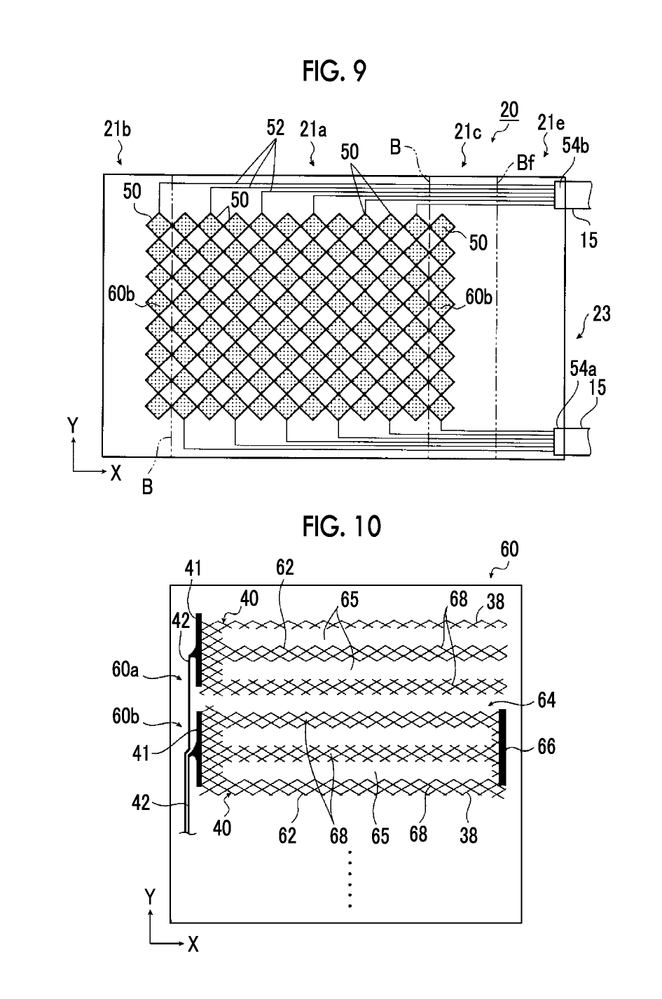

The form of routing the second wiring 52 may have a configuration shown in FIG. 9.

FIG. 9 is a schematic view showing another example of the arrangement of the second conductive layers and the second wirings in the laminate of the laminate structure according to the embodiment of the invention. FIG. 9 shows a laminate 20 in a plan view like FIG. 5. In the laminate 20 shown in FIG. 9, the same components as those of the laminate 20 shown in FIG. 8 are represented by the same reference numerals, and detailed description thereof will not be repeated.

Like the laminate 20 shown in FIG. 9, the second wirings 52 are led from both ends in the Y direction and are respectively routed from the region 21c to the tip 23 of the region 21e corresponding to the tip 13 of the protrusion portion 12e, and the second wirings 52 are respectively connected to a first terminal 54a and a second terminal 54b provided at both ends in the Y direction of the tip 23 of the region 21e.

In this case, the second wirings 52 of six second conductive layers 50 are connected to the first terminal 54a, and the second wirings 52 of six second conductive layers 50 are connected to the second terminal 54b. While the number of terminals and the number of connections of the second wirings 52 of the second conductive layers 50 are not particularly limited, it is preferable that the number of connections to each terminal is identical, and the second wirings 52 have the same length. With this, it is possible to achieve uniformity of wiring resistance, and for example, to reduce variation in sensing characteristics.

Even in the laminate 20 shown in FIG. 9, the second wirings 52 are led from both ends in the Y direction and are routed to the region 21e by way of the region 21c, the second wirings 52 are concentrated on the region 21e, and the two FPCs 15 are provided at the tip 23 of the region 21e, whereby it is possible to simplify the configuration compared to a case where terminals are provided at both ends of the region 21a in the Y direction and two FPCs are connected to the terminals. Since no terminal is provided in the region 21a, it is possible to make the region of the decorative printing for hiding the terminal small.

As described above, the FPCs 15 are respectively connected to the first terminal 54a and the second terminal 54b. In order to shorten the total length of the wiring distances of the FPCs and to suppress an increase in the number of connection locations to the controller 14, it is preferable that connection is made to the first terminal 54a and the second terminal 54b using an FPC which is a single wiring member and has, for example, branch portions corresponding to the number of terminals. For example, it is preferable that connection is made using an FPC having two branch portions.

Even in the laminate 20 shown in FIG. 9, the second wirings 52 are concentrated on the protrusion portion 12e, and the FPCs 15 are provided at the first terminal 54a and the second terminal 54b provided at both ends in the Y direction of the tip 23 of the region 21e, whereby it is possible to shorten the wiring distance of the FPC 15 to the controller 14. With this, it is possible to suppress the influence of noise.

Since the first conductive layers 40 and the second conductive layers 50 are formed in different layers even in the configuration of any of the laminate 20, the laminate 20a, the laminate 20b, and the laminate 20c, the FPCs 15 are not connected to the same layer, and a combination of the first conductive layers 40 and the second conductive layers 50 is not particularly limited. Any combination of FIGS. 5 and 8, FIGS. 5 and 9, FIGS. 6 and 8, FIGS. 6 and 9, FIGS. 7 and 8, and FIGS. 7 and 9 may be made. In the combination of FIGS. 5 and 8, the FPCs 15 can be connected at the same position at the tip 13 of the protrusion portion 12e. In the combination of FIGS. 6 and 9, the three terminals are provided at the tip 13 of the protrusion portion 12e, and for example, connection can be made using the FPC 17 shown in FIG. 7. As will be understood from the drawings, it is preferable to concentrate 90% or more of a plurality of wirings (first wirings 42 and second wirings 52) led out from a plurality of conductive layers on the protrusion portion 12e, and it is most preferable to concentrate all of a plurality of wirings (first wirings 42 and second wirings 52) on the protrusion portion 12e.

In order to make the total length of the first wirings 42 of the first conductive layers 40 shorter than the total length of the second wirings 52 of the second conductive layers 50, it is preferable to concentrate the terminal 44 on the protrusion portion 12e to which the first wirings 42 connected to the first conductive layers 40 are routed.

The total length of the first wiring 42 is made shorter than the total length of the second wirings 52, whereby it is possible to reduce noise to the first wirings 42 and to further facilitate sensing of the first conductive layers 40 across the bending portion B.

In the forms shown in FIGS. 5 to 9, although description has been described using the laminate 20, the configuration of the laminate is not limited thereto, and any of the laminates 20a, 20b, and 20c may be applied. The transparent conductive members 30 and 30a may protrude from the protective member 32, and in a case where the adhesive layer 34 is provided, may protrude from the protective member 32 and the adhesive layer 34.

The form of the display device with a touch panel is not limited to the display device 10 with a touch panel shown in FIG. 1, and a configuration may be made in which either of the first conductive layers 40 or the second conductive layers 50 are provided. In this case, the position in a direction of either of the X direction or the Y direction is detected.

Next, a first conductive pattern 60 of the first conductive layers 40 will be described.

FIG. 10 is a schematic view showing an example of a first conductive pattern of the first conductive layers in the laminate of the laminate structure according to the embodiment of the invention.

As shown in FIG. 10, the first conductive layers 40 have a first conductive pattern 60 constituted of a plurality of lattices 62 extending in the X direction by the fine metal wires 38. A plurality of lattices 62 have a substantially uniform shape. The term “substantially uniform” means that the lattices 62 have the same shape and size at a glance, in addition to a case where the lattices completely coincide with one another. The first conductive pattern 60 has two patterns including a first first conductive pattern 60a and a second first conductive pattern 60b.

Each first conductive layer 40 is electrically connected to a first electrode terminal 41 at one end thereof. Each first electrode terminal 41 is electrically connected to one end of each first wiring 42. Each first wiring 42 is electrically connected to the terminal 44 (see FIG. 5) at the other end thereof. The first first conductive pattern 60a and the second first conductive pattern 60b are electrically separated from each other by a first non-conductive pattern 64.

In a case of being used as a transparent conductive film provided before a display requiring visibility, as the first non-conductive pattern 64, a dummy pattern constituted of the fine metal wires 38 having a disconnection portion described below is formed. In a case of being used as a transparent conductive film provided before a notebook personal computer, a touch pad, or the like particularly requiring visibility, as the first non-conductive pattern 64, a dummy pattern constituted of the fine metal wires is not formed and a space is left.

The first first conductive pattern 60a and the second first conductive pattern 60b comprise slit-like non-conduction patterns 65 for electric separation, and comprise a plurality of first conductive pattern columns 68 divided by the respective non-conduction patterns 65.

In a case of being used as a transparent conductive film provided before a display requiring visibility, as the non-conduction patterns 65, a dummy pattern constituted of the fine metal wires 38 having a disconnection portion described below is formed. In a case of being used as a transparent conductive film provided before a notebook personal computer, a touch pad, or the like particularly requiring visibility, as the non-conduction patterns 65, a dummy pattern constituted of the fine metal wires 38 is not formed and a space is left.

The first first conductive pattern 60a comprises the slit-like non-conduction patterns 65 whose the other end is opened as shown on the upper side of FIG. 10. Since the other end is opened, the first first conductive pattern 60a becomes a comb-like structure. The first first conductive pattern 60a has three first conductive pattern columns 68 formed by the two non-conductions patterns 65. The first conductive pattern columns 68 are respectively connected to the first electrode terminal 41, and thus, become the same potential.

The second first conductive pattern 60b comprises an additional first electrode terminal 66 at the other end as shown on the lower side of FIG. 10. The slit-like non-conduction patterns 65 are closed in the first conductive pattern 60. The additional first electrode terminal 66 is provided, whereby it is possible to easily perform the inspection of the first conductive pattern 60. The second first conductive pattern 60b has three first conductive pattern columns 68 formed by the two closed non-conduction patterns 65. The first conductive pattern columns 68 are respectively connected to the first electrode terminal 41 and the additional first electrode terminal 66, and thus, become the same potential. The first conductive pattern columns are one modification example of the comb-like structure.

The number of first conductive pattern columns 68 may be equal to or greater than two, equal to or less than ten, and preferably, is determined in consideration of the relationship with pattern design of the fine metal wires 38 within a range of equal to or less than seven.

The pattern shapes of the fine metal wires of the three first conductive pattern columns 68 may be identical or different. In FIG. 10, the respective first conductive pattern columns 68 have different shapes. In the first first conductive pattern 60a, the uppermost first conductive pattern column 68 out of the three first conductive pattern columns 68 is constituted by extending adjacent inverted V-shaped fine metal wires 38 in the X direction while intersecting each other. The upper first conductive pattern column 68 becomes a structure in which the lattices 62 do not have a complete shape with no lower vertical angle. The central first conductive pattern column 68 is constituted in two columns by extending the lattices 62 in the X direction while bringing the sides of adjacent lattices 62 into contact with each other. The lowermost first conductive pattern column 68 is constituted by extending the lattices 62 in the X direction while bringing the vertical angles of adjacent lattices 62 into contact with each other, and extending one side of each lattice 62.

In the second first conductive pattern 60b, the uppermost first conductive pattern column 68 and the lowermost first conductive pattern column 68 have the substantially same lattice shape, and are constituted in two columns by extending the lattices 62 in the X direction while bringing the sides of adjacent lattices 62 into contact with each other. The central first conductive pattern column 68 of the second first conductive pattern 60b is constituted by extending the lattices 62 in the X direction while bringing the vertical angles of adjacent lattices 62 into contact with each other, and extending one side of each lattice 62.

Next, a second conductive pattern 70 of the second conductive layer 50 will be described.

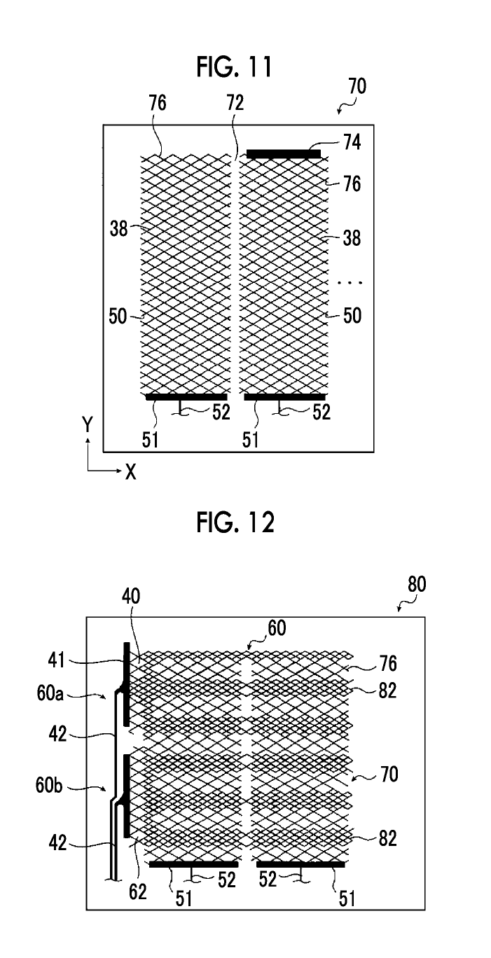

FIG. 11 is a schematic view showing an example of a second conductive pattern of the second conductive layers in the laminate of the laminate structure according to the embodiment of the invention.

As shown in FIG. 11, the second conductive pattern 70 is constituted of multiple lattices by the fine metal wires 38. The second conductive pattern 70 has a plurality of second conductive layers 50 which extend in the Y direction and are arranged in parallel in the X direction. The respective second conductive layers 50 are electrically separated from each other by a second non-conductive pattern 72.

In a case of being used as a transparent conductive film provided before a display requiring visibility, as the second non-conductive pattern 72, a dummy pattern constituted of the fine metal wires 38 having a disconnection portion is formed. In a case of being used as a transparent conductive film provided before a notebook personal computer, a touch pad, or the like particularly requiring visibility, as the second non-conductive pattern 72, a dummy pattern constituted of the fine metal wires 38 is not formed and a space is left.

The respective second conductive layers 50 are electrically connected to terminals 51. Respective terminals 51 are electrically connected to the conductive second wirings 52. The respective second conductive layers 50 are electrically connected to the terminals 51 at one end thereof. The respective terminals 51 are electrically connected to one end of the respective second wirings 52. The respective second wirings 52 are electrically connected to the terminal 54 (see FIG. 1) at the other end thereof. In the second conductive pattern 70, the second conductive layers 50 have a striped structure having a substantially constant width in the Y direction, but are not limited to the striped shape.

The second conductive pattern 70 may be provided with an additional second electrode terminal 74. The additional second electrode terminal 74 is provided, whereby it is possible to easily perform the inspection of the second conductive pattern 70.

In FIG. 11, the second conductive layer 50 with no additional second electrode terminal 74 and the second conductive layer 50 with the additional second electrode terminal 74 are formed on the same surface. However, the second conductive layer 50 with the additional second electrode terminal 74 and the second conductive layer 50 with no additional second electrode terminal 74 do not need to be mixed, and only one second conductive layer 50 may be formed.

The second conductive pattern 70 includes a plurality of lattices 76 constituted of the fine metal wires 38 intersecting each other, and the lattices 76 have the substantially same shape as the lattices 62 of the first conductive pattern 60. The length of one side of the lattices 76 and the aperture ratio of the lattices 76 are the same as the lattices 62 of the first conductive pattern 60.

FIG. 12 shows a combination pattern obtained by arranging the first conductive pattern 60 having a comb-like structure and the second conductive pattern 70 having a striped structure to face each other. The first conductive pattern 60 and the second conductive pattern 70 are orthogonal to each other, and a combination pattern 80 is formed by the first conductive pattern 60 and the second conductive pattern 70.

The combination pattern 80 shown in FIG. 12 is a combination of the first conductive pattern 60 with no dummy pattern and the second conductive pattern 70 with no dummy pattern.

In the combination pattern 80, in a top view, small lattices 82 are formed by the lattices 62 and the lattices 76. That is, intersections of the lattices 62 are provided substantially at the center of the opening regions of the lattices 76. The small lattices 82 have one side having a length corresponding to half the length of one side of the lattices 62 and the lattices 76. The length of one side is, for example, equal to or greater than 125 μm and equal to or less than 450 μm, and preferably, equal to or greater than 150 μm and equal to or less than 350 μm.

Next, a first example of a method of manufacturing the display device 10 with a touch panel of this embodiment will be described.

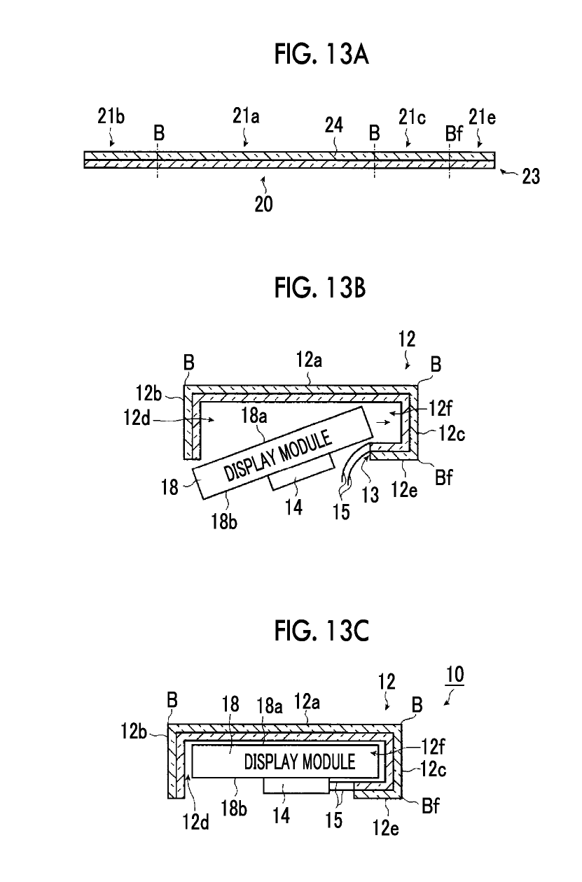

FIGS. 13A to 13C are schematic views showing a first example of a method of manufacturing a display device with a touch panel according to the embodiment of the invention in a process order.

As shown in FIG. 13A, first, a structure in which the cover member 24 is laminated to the entire surface of the flat plate-shaped laminate 20 through the adhesive layer 22 (see FIG. 2A) is prepared. The adhesive layer 22 (see FIG. 2A) is not shown. The adhesive layer may not be provided.

The laminate 20 is divided into the region 21a corresponding to the planar portion 12a and the regions 21b and 21c corresponding to the side portions 12b and 12c by the bending portions B, and is further divided into the region 21e corresponding to the protrusion portion 12e by the bending portion Bf. The cover member 24 extends to the region 21e.

The laminate 20 is made in a stereoscopic shape by bending both ends thereof nearly at right angles in the bending portions B along with the cover member 24 with the laminate 20 placed inside to form the side portions 12b and 12c as shown in FIG. 13B and bending the bending portion Bf nearly at right angles to the side portion 12c to form the protrusion portion 12e. At this time, the side portions 12b and 12c are nearly at right angles to the planar portion 12a, and the protrusion portion 12e is nearly parallel to the planar portion 12a and faces the planar portion 12a. Next, the FPC 15 is attached to the tip 13 of the protrusion portion 12e.

Next, the end of the display module 18 is inserted into the region 12f surrounded by the planar portion 12a, the side portion 12c, and the protrusion portion 12e such that the display surface 18a of the display module 18 turns toward the recess portion 12d side, and hooked. Then, as shown in FIG. 13C, the display module 18 is fitted into the recess portion 12d, and the display module 18 is attached. This attachment can be performed, for example, by attaching the optically transparent pressure sensitive adhesive (OCA) or optically transparent resin (OCR) to the display surface 18a. The attachment may be performed without using the optically transparent pressure sensitive adhesive (OCA) and optically transparent resin (OCR).

Then, the FPC 15 is connected to the controller 14. With this, it is possible to form the display device 10 with a touch panel.

The region 12f is surrounded by the cover member 24, and in a case where the cover member 24 is formed of, for example, polycarbonate, it is possible to obtain sufficient rigidity. With this, even if the display module 18 is hooked to the region 12f, the display module 18 is stable, whereby it is possible to easily attach the display module 18.

When bending the laminate 20 with the cover member 24 laminated on the entire surface thereof, for example, the laminate 20 is bent while heating to a temperature determined in advance, and is then cooled to room temperature. In regard to bending of the laminate 20 described above, known methods of bending a resin material can be suitably used. The side portions 12b and 12c and the protrusion portion 12e may be formed by one-step bending, or may be formed by two-step bending in which the protrusion portion 12e is formed after forming the side portions 12b and 12c are formed.

Next, a second example of the method of manufacturing the display device 10 with a touch panel of this embodiment will be described.

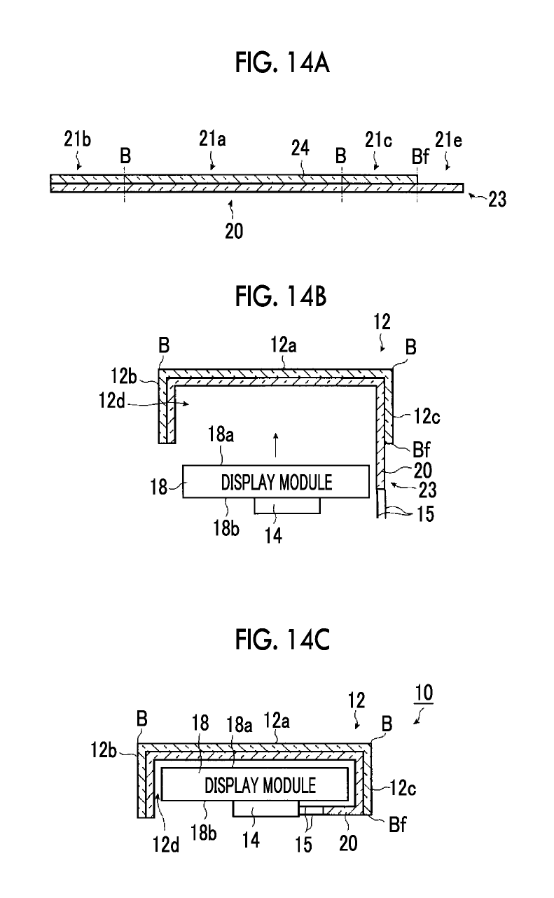

FIGS. 14A to 14C are schematic views showing a second example of the method of manufacturing a display device with a touch panel according to the embodiment of the invention in a process order.

In the diagrams illustrating the second example of the method of manufacturing the display device with a touch panel shown in FIGS. 14A to 14C, the same components as those in the drawings illustrating the first example of the method of manufacturing the display device with a touch panel shown in FIGS. 13A to 13C are represented by the same reference numerals, and detailed description thereof will not be repeated.

In the second example of the method of manufacturing the display device 10 with a touch panel, detailed description of the same steps as those in the first example of the method of manufacturing the display device 10 with a touch panel shown in FIGS. 13A to 13C will not be repeated.

The second example of the method of manufacturing the display device 10 with a touch panel is different from the first example of the method of manufacturing the display device 10 with a touch panel in that, as shown in FIG. 14A, while the cover member 24 is laminated in the region 21a and the regions 21b and 21c of the laminate 20, the cover member 24 is not provided in the region 21e. As shown in FIG. 14A, the region 21e is constituted only by the laminate 20.

The laminate 20 is made in a stereoscopic shape by bending both ends thereof nearly at right angles in the bending portions B along with the cover member 24 with the laminate 20 placed inside to form the side portions 12b and 12c as shown in FIG. 14B. Since the cover member 24 is not provided on the entire surface of the laminate 20, in this step, the protrusion portion 12e is not formed. Then, the FPC 15 is attached to the tip 23 of the laminate 20.

Next, the display module 18 is housed in the recess portion 12d such that the display surface 18a of the display module 18 turns toward the recess portion 12d, and as shown in FIG. 14C, the display module 18 is attached to the recess portion 12d. This attachment can be performed, for example, by attaching the optically transparent pressure sensitive adhesive (OCA) or optically transparent resin (OCR) described above to the display surface 18a as in the first example.

Then, the laminate 20 is bent toward the rear surface 18b side of the display module 18 to form the protrusion portion 12e, and the FPC 15 is connected to the controller 14. With this, it is possible to form the display device 10 with a touch panel.

Next, a third example of the method of manufacturing the display device 10 with a touch panel of this embodiment will be described.

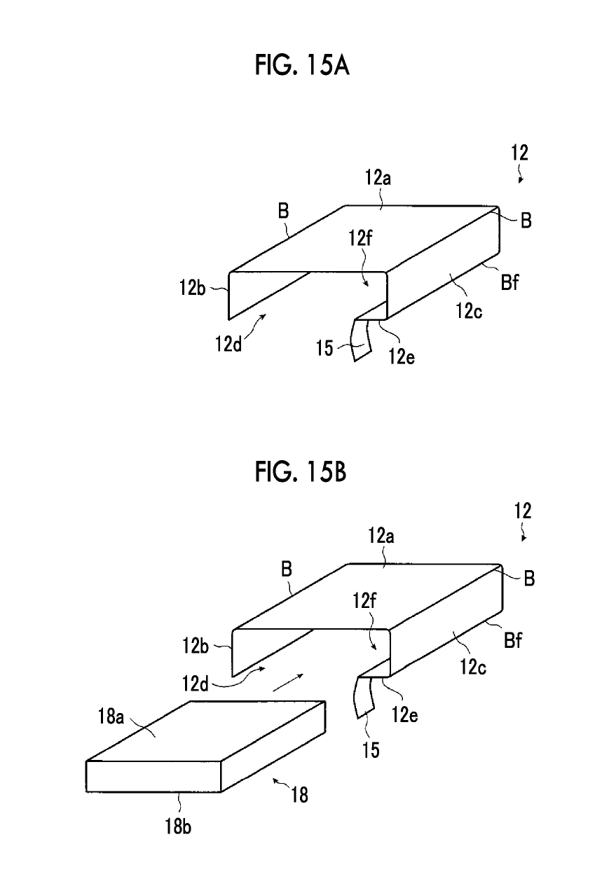

FIGS. 15A and 15B are schematic views showing a third example of the method of manufacturing a display device with a touch panel according to the embodiment of the invention in a process order.

In the diagrams illustrating the third example of the method of manufacturing the display device with a touch panel shown in FIGS. 15A and 15B, the same components as those in the drawings illustrating the first example of the method of manufacturing the display device with a touch panel shown in FIGS. 13A to 13C are represented by the same reference numerals, and detailed description thereof will not be repeated.

In the third example of the method of manufacturing the display device 10 with a touch panel, detailed description of the same steps as those in the first example of the method of manufacturing the display device 10 with a touch panel shown in FIGS. 13A to 13C will not be repeated.

The third example of the method of manufacturing the display device with a touch panel is the same as the first example of the method of manufacturing the display device with a touch panel, except that the attachment method of the display module 18 is different from that in the first example of the method of manufacturing the display device with a touch panel, and thus, detailed description thereof will not be repeated.

In the third example of the manufacturing method, as shown in FIG. 15A, the laminate 20 with the cover member 24 provided on the entire surface thereof is formed in a stereoscopic shape having the planar portion 12a, the side portions 12b and 12c, and the protrusion portion 12e. The stereoscopic shape shown in FIG. 15A is stereoscopic vision of the planar shape shown in FIG. 13B.

Next, as shown in FIG. 15B, the display module 18 is inserted and fitted into the recess portion 12d by sliding from a direction orthogonal to the connection direction of the planar portion 12a and the side portions 12b and 12c. Then, as shown in FIG. 13C, the controller 14 on the rear surface 18b of the display module 18 and the FPC 15 are connected. With this, it is possible to obtain the display device 10 with a touch panel.

In all of the methods of manufacturing the display device 10 with a touch panel described above, although the display module 18 is provided after the FPC 15 is provided, the invention is not limited thereto. For example, the FPC 15 may be attached after the display module 18 is attached.

The invention is basically configured as described above. Although the laminate structure, the touch panel, the display device with a touch panel, and the method of manufacturing the same of the invention have been described above in detail, the invention is not limited to the foregoing embodiment, and various improvements or modifications may be made without departing from the scope of the invention.

### EXPLANATION OF REFERENCES

10: display device with touch panel
12: laminate structure
12a: planar portion
12b, 12c: side portion
12e: protrusion portion
14: controller
15: flexible circuit board (FPC)
16: touch panel
18: display module
20, 20a, 20b, 20c: laminate
22, 34: adhesive layer
24: cover member
30, 30a: transparent conductive member
32: protective member
36: transparent substrate
38: fine metal wire
40: first conductive layer
42: first wiring
44, 54: terminal
50: second conductive layer
52: second wiring
60: first conductive pattern
70: second conductive pattern

What is claimed is:

1. A laminate structure which has a three-dimensional shape and includes an optically transparent region, the laminate structure comprising:
a transparent conductive member provided with at least one conductive layer constituted of fine metal wires on a flexible transparent substrate;
a wiring formed on the transparent substrate and electrically connected to the conductive layer; and
a cover member protecting the transparent conductive member,
wherein the three-dimensional shape is constituted of at least a planar portion, a side portion bent continuously to the planar portion, and a protrusion portion continued to the side portion and bent with respect to the side portion,
out of the planar portion, the side portion, and the protrusion portion, the planar portion and the side portion are constituted of the cover member and the transparent conductive member, and the protrusion portion is constituted of at least the transparent conductive member, and
the wiring is routed to at least the protrusion portion and is connected to a flexible wiring member at the tip of the protrusion portion of the transparent conductive member.

2. The laminate structure according to claim 1,
wherein the protrusion portion is constituted only of the transparent conductive member.

3. The laminate structure according to claim 1,
wherein the protrusion portion is constituted of the cover member and the transparent conductive member.

4. The laminate structure according to claim 1,
wherein the side portions are provided on both sides of the planar portion, and the protrusion portion is provided in one side portion.

5. The laminate structure according to claim 2,
wherein the side portions are provided on both sides of the planar portion, and the protrusion portion is provided in one side portion.

6. The laminate structure according to claim 1,
wherein the protrusion portion faces the planar portion and is provided substantially in parallel with the planar portion.

7. The laminate structure according to claim 2,
wherein the protrusion portion faces the planar portion and is provided substantially in parallel with the planar portion.

8. The laminate structure according to claim 1, further comprising:
an optically transparent pressure sensitive adhesive layer between the transparent conductive member and the cover member.

9. The laminate structure according to claim 1,
wherein the wiring member is connected to an external apparatus.

10. The laminate structure according to claim 1,
wherein the transparent conductive member is provided inside the three-dimensional shape with respect to the cover member.

11. The laminate structure according to claim 1,
wherein the conductive layer has a conductive pattern having a mesh structure constituted of the fine metal wires.

12. The laminate structure according to claim 1,
wherein the conductive layers are formed on both surfaces of the transparent substrate.

13. The laminate structure according to claim 1,
wherein the conductive layer is formed on one surface of the transparent substrate, and two transparent substrates on which the conductive layer is formed on one surface are laminated.

14. A display device comprising:
a touch panel; and
a display module,
wherein the touch panel includes
a laminate structure which has a three-dimensional shape and includes an optically transparent region,
the laminate structure includes
a transparent conductive member provided with at least one conductive layer constituted of fine metal wires on a flexible transparent substrate,
a wiring formed on the transparent substrate and electrically connected to the conductive layer, and
a cover member protecting the transparent conductive member,
the three-dimensional shape is constituted of at least a planar portion, a side portion bent continuously to the planar portion, and a protrusion portion continued to the side portion and bent with respect to the side portion,
out of the planar portion, the side portion, and the protrusion portion, the planar portion and the side portion are constituted of the cover member and the transparent conductive member, and the protrusion portion is constituted of at least the transparent conductive member,
the wiring is routed to at least the protrusion portion and is connected to a flexible wiring member at the tip of the protrusion portion of the transparent conductive member, and
the display module is housed in a recess portion constituted of the planar portion, the side portion, and the protrusion portion of the laminate structure.

15. The display device according to claim 14,
wherein a projection for positioning the display module is provided in the protrusion portion.

16. A method of manufacturing a display device with a touch panel having the laminate structure according to claim 1, the method comprising:
a step of obtaining a laminate structure having a three-dimensional shape constituted of the planar portion, the side portion formed to be bent continuously to the planar portion, and the protrusion portion continued to the side portion and bent with respect to the side portion; and
a step of mounting a display module in a recess portion constituted of the planar portion, the side portion, and the protrusion portion.

17. The method of manufacturing a display device with a touch panel according to claim 16,
wherein the protrusion portion is constituted of the transparent conductive member or the cover member and the transparent conductive member.

18. The method of manufacturing a display device with a touch panel according to claim 16,
wherein the display module is mounted while sliding with respect to the recess portion.

19. The method of manufacturing a display device with a touch panel according to claim 17,
wherein the display module is mounted while sliding with respect to the recess portion.
